(19) United States
(12) Patent Application Publication
(10) Pub. No.: US 2024/0070614 A1
(43) Pub. Date: Feb. 29, 2024

(54) METHODS FOR LOCATION MAPPING TO FACILITATE COLLABORATION FOR USERS SHARING COMMON ATTRIBUTES AND DEVICES THEREOF

(71) Applicant: JONES LANG LASALLE IP, INC., Chicago, IL (US)

(72) Inventors: Kourosh Sadr MOMTAZ, Richmond (GB); Laura TEDOLDI, Paris (FR); Yu-Chun TSAI, San Jose, CA (US); Samantha AKOMEAH, London (GB)

(21) Appl. No.: 17/900,476

(22) Filed: Aug. 31, 2022

(51) Int. Cl. G06Q 10/10; H04W 64/00

(52) U.S. Cl. CPC G06Q 10/10; H04W 64/003

(57) ABSTRACT

Methods, non-transitory computer readable media, and collaboration management devices are disclosed that identify a venue and registered users within a first radius of a venue geolocation of the venue. The venue satisfies venue parameters received from a client device and the venue geolocation is within a second radius of a user geolocation of an authenticated user. Social data for the venue generated from user data for the registered users is output to the client device. Digital invitations are sent to client devices associated with the registered users. A notification is output to the client device that includes user data for a subset of the registered users from which a positive response to the digital invitations was received. Visit data for the venue is updated to reflect a visit to the venue by the authenticated user and the subset of the registered users.

### FIELD

This technology generally relates to collaboration management systems and digital platforms and, more particularly, to methods and devices for using location mapping to facilitate in-person collaboration at physical venues for users sharing common attributes.

### BACKGROUND

Employees and other workers are increasingly performing many job functions remotely. The advent of significant remote work has resulting in less in-person collaborative and spontaneous meetings that have the potential to benefit an organization not only with respect to the generation of ideas beneficial to the organization but also with respect to organization culture and coworker relationships. Additionally, employees for relatively large corporations, for example, often travel to remote offices different from their home offices. These employees and the associated corporations could benefit from meeting an increased number of coworkers based in the remote offices.

However, many of these colleagues may also work remotely and therefore cannot, or are less likely to, be found in those remote offices. Unfortunately, there is currently no effective way to facilitate remote co-working and other types of collaborations and social interactions between employees, for example, that share a common attribute (e.g., same enterprise and/or same team, role, department, and/or business unit).

In the above scenario, the employee traveling to a remote office is currently unable to identify, or meet at a public venue separate from the remote office, any coworkers based in the remote office but working remotely from that office. At a more granular level, an employee has no way to determine whether there are coworkers within a geographic proximity of the local coffee shop, or other public venue the employee has decided to work at for the morning, that may be interested in co-working at the same location for collaborative or social purposes, for example, irrespective of whether the public venue is located near the employee's home or remote office.

### SUMMARY

A method for location mapping to facilitate collaboration for users sharing common attributes is disclosed that is implemented by one or more collaboration management devices and includes identifying a venue and one or more registered users within a first radius of a venue geolocation of the venue. The venue satisfies one or more venue parameters received from a client device and the venue geolocation is within a second radius of a user geolocation of an authenticated user of the client device. Social data for the venue generated from stored user data for the registered users is output to the client device. One or more digital invitations are sent to one or more client devices associated with one or more of the registered users. A notification is output to the client device that includes at least a portion of the stored user data for at least a subset of the one or more of the registered users associated with one or more of the client devices from which a positive response to the digital invitations was received. Stored visit data for the venue is updated to reflect a visit to the venue by the authenticated user and the subset of the one or more of the registered users.

A collaboration management device is disclosed that includes memory including programmed instructions stored thereon and one or more processors configured to execute the stored programmed instructions to identify a venue and one or more registered users within a first radius of a venue geolocation of the venue. The venue satisfies one or more venue parameters received from a client device and the venue geolocation is within a second radius of a user geolocation of an authenticated user of the client device. Social data for the venue generated from stored user data for the registered users is output to the client device. One or more digital invitations are sent to one or more client devices associated with one or more of the registered users. A notification is output to the client device that includes at least a portion of the stored user data for at least a subset of the one or more of the registered users associated with one or more of the client devices from which a positive response to the digital invitations was received. Stored visit data for the venue is updated to reflect a visit to the venue by the authenticated user and the subset of the one or more of the registered users.

A non-transitory computer readable medium having stored thereon instructions for location mapping to facilitate collaboration for users sharing common attributes is disclosed that includes executable code that, when executed by one or more processors, causes the one or more processors to identify a venue and one or more registered users within a first radius of a venue geolocation of the venue. The venue satisfies one or more venue parameters received from a client device and the venue geolocation is within a second radius of a user geolocation of an authenticated user of the client device. Social data for the venue generated from stored user data for the registered users is output to the client device. One or more digital invitations are sent to one or more client devices associated with one or more of the registered users. A notification is output to the client device that includes at least a portion of the stored user data for at least a subset of the one or more of the registered users associated with one or more of the client devices from which a positive response to the digital invitations was received. Stored visit data for the venue is updated to reflect a visit to the venue by the authenticated user and the subset of the one or more of the registered users.

This technology provides a number of advantages including methods, non-transitory computer readable media, and collaboration management devices that advantageously obtain and correlate current geolocations for users of client devices with a venue geolocation of a venue selected by a user to generate and provide social data to the user regarding the other users in relatively close proximity to the venue. This technology can then automatically initiate digital invitations to the client devices associated with the other users that indicate the venue and a time window input by the user. Accordingly, users sharing attributes optionally reflected in the social data (e.g., users work for the same corporate entity) can collaborate, socialize, or work in parallel at the venue during the selected time window to thereby facilitate increased interactions among the users and improve the connections and culture of an associated organization.

### BRIEF DESCRIPTION OF THE DRAWINGS

FIG. 1 is a block diagram of an exemplary network environment with a collaboration management device;

FIG. 2 is a block diagram of an exemplary collaboration management device;

FIG. 3 is a flowchart of an exemplary method for location mapping to facilitate collaboration for users sharing common attributes;

FIG. 4 is an exemplary venue parameter interface;

FIG. 5 is an exemplary venue preview interface;

FIG. 6 is an exemplary venue selection interface;

FIG. 7 is an exemplary scheduling interface;

FIG. 8 is an exemplary calendaring interface; and

FIG. 9 is an exemplary response interface.

### DETAILED DESCRIPTION

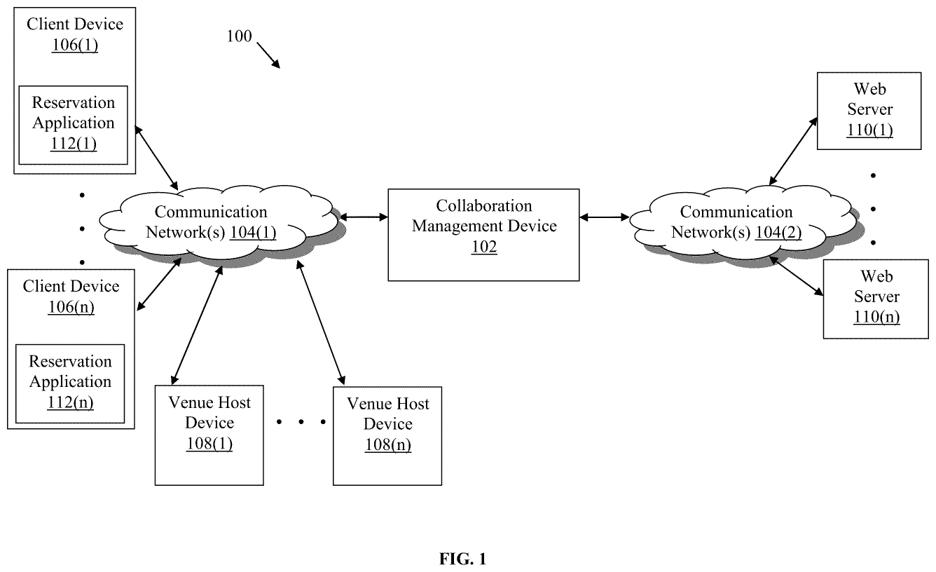

Referring to FIG. 1, an exemplary network environment 100 is illustrated that includes a collaboration management device 102 coupled, via communication network(s) 104(1), to client devices 106(1)-106(n) and optional venue host devices 108(1)-108(n) and, via communication network(s) 104(2), web servers 110(1)-110(n). The network environment 100 may include other network devices such as one or more routers or switches, for example, which are known in the art and thus will not be described herein. This technology provides a number of advantages including methods, non-transitory computer readable media, and collaboration management devices that analyze registered user and selected venue geolocations to generate and output social data to inform a selection of a venue by a particular user and facilitate digital invitations for the venue and a selected time window. Accordingly, this technology facilitates meeting or co-working arrangements at convenient locations to reduce travel time and improve collaboration among users with common attributers.

In this particular example, the client devices 106(1)-106(n), venue host devices 108(1)-108(n), collaboration management device 102, and web servers 110(1)-110(n) are disclosed in FIG. 1 as dedicated hardware devices. However, one or more of the client devices 106(1)-106(n), venue host devices 108(1)-108(n), collaboration management device 102, or web servers 110(1)-110(n) can also be implemented in software within one or more other devices in the network environment 100. As one example, the collaboration management device 102, as well as any of its components or applications, can be implemented as software executing on one of the web servers 110(1)-110(n), and many other permutations and types of implementations and network topologies can also be used in other examples.

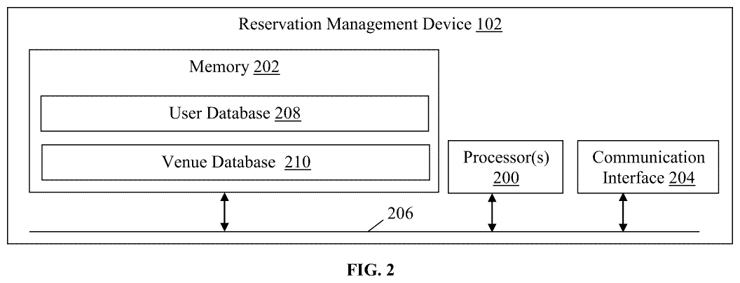

Referring to FIGS. 1-2, the collaboration management device 102 of the network environment 100 may perform any number of functions, including providing graphical user interfaces (GUIs) to the client devices 106(1)-106(n) and/or venue host devices 108(1)-108(n) and communicating with the web servers 110(1)-110(n) to facilitate user meetings at particular venues. The collaboration management device 102 in this example includes one or more processor(s) 200, a memory 202, and a communication interface 204, which are coupled together by a bus 206, although the collaboration management device 102 can include other types or numbers of elements in other configurations.

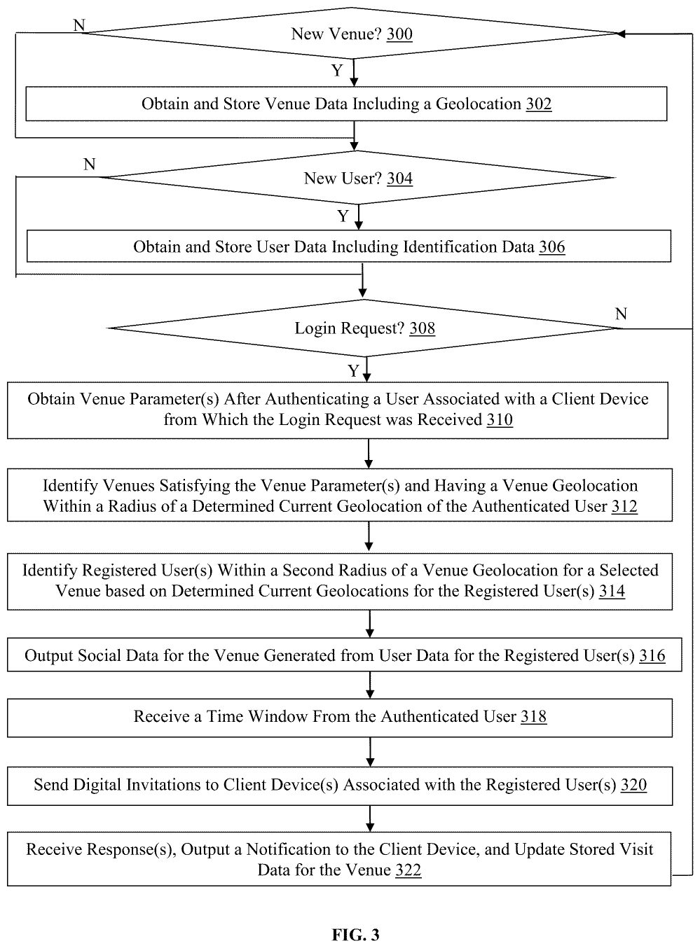

The processor(s) 200 of the collaboration management device 102 may execute programmed instructions stored in the memory 202 of the collaboration management device 102 for any number of the functions described and illustrated herein (e.g., with reference to FIG. 3). The processor(s) 200 may include one or more central processing units (CPUs) or general purpose processors with one or more processing cores, for example, although other types of processor(s) can also be used.

The memory 202 of the collaboration management device 102 stores these programmed instructions for one or more aspects of the present technology as described and illustrated herein, although some or all of the programmed instructions could be stored elsewhere. A variety of different types of memory storage devices, such as random access memory (RAM), read only memory (ROM), hard disk, solid state drives, flash memory, or other computer readable medium which is read from and written to by a magnetic, optical, or other reading and writing system that is coupled to the processor(s) 200, can be used for the memory 202.

Accordingly, the memory 202 can store applications that can include computer executable instructions that, when executed by the collaboration management device 102, cause the collaboration management device 102 to perform actions, such as to transmit, receive, or otherwise process network messages and requests, for example, and to perform other actions described and illustrated below with reference to FIGS. 3-9. The application(s) can be implemented as components of other applications, operating system extensions, and/or plugins, for example.

Further, the application(s) may be operative in a cloud-based computing environment with access provided via a software-as-a-service model. The application(s) can be executed within or as virtual machine(s) or virtual server(s) that may be managed in a cloud-based computing environment. Also, the application(s), and even the collaboration management device 102 itself, may be located in virtual server(s) running in a cloud-based computing environment rather than being tied to specific physical network computing devices. Also, the application(s) may be running in virtual machines (VMs) executing on the collaboration management device 102 and managed or supervised by a hypervisor.

In this particular example, the memory 202 includes a user database 208 and a venue database 210. The user database 208 stores user data received from the client devices 106(1)-106(n) via the collaboration applications 112(1)-112(n) executing thereon, such as identification data, login credentials, and/or an indication of an associated organization, role, team, business unit, and/or department, for example. The venue database stores venue data obtained from the venue host devices 108(1)-108(n), such as geolocation/address, type (e.g., coffee shop, restaurant, bar) size, and/or amenities, for example. Other information can be stored in one or more of the user database 208 or the venue database 210 in other examples, and other data stores and/or applications or modules also can be hosted by the collaboration management device 102 in other examples.

The communication interface 204 of the collaboration management device 102 operatively couples and communicates between the collaboration management device 102, client devices 106(1)-106(n), venue host devices 108(1)-108(n) and web servers 110(1)-110(n), which are coupled together at least in part by the communication network(s) 104(1) and 104(2), although other types or numbers of communication networks or systems with other types or numbers of connections or configurations to other devices or elements can also be used.

By way of example only, the communication network(s) 104(1) and 104(2) can include local area network(s) (LAN(s)) or wide area network(s) (WAN(s)), and can use TCP/IP over Ethernet and industry-standard protocols, although other types or numbers of protocols or communication networks can be used. The communication network(s) 104(1) and 104(2) in this example can employ any suitable interface mechanisms and network communication technologies including, for example, Ethernet-based Packet Data Networks (PDNs).

While the collaboration management device 102 is illustrated in this example as including a single device, the collaboration management device 102 in other examples can include a plurality of devices each having one or more processors (each processor with one or more processing cores) that implement one or more steps of this technology. In these examples, one or more of the devices can have a dedicated communication interface or memory. Alternatively, one or more of the devices can utilize the memory, communication interface, or other hardware or software components of one or more other devices included in the collaboration management device 102. Additionally, one or more of the devices that together comprise the collaboration management device 102 in other examples can be standalone devices or integrated with one or more other devices or apparatuses.

Each of the client devices 106(1)-106(n) of the network environment 100 in this example includes any type of computing device that can exchange network data, such as mobile, desktop, laptop, or tablet computing devices, virtual machines (including cloud-based computers), or the like. Each of the client devices 106(1)-106(n) in this example includes a processor, a memory, and a communication interface, which are coupled together by a bus or other communication link (not illustrated), although other numbers or types of components could also be used.

Each of the client devices 106(1)-106(n) may run interface applications, such as standard web browsers or the standalone collaboration applications 112(1)-112(n), which may provide an interface to communicate with the collaboration management device 102 via the communication network(s) 104(1). Each of the client devices 106(1)-106(n) may further include a display device, such as a display screen or touchscreen, or an input device, such as a keyboard or mouse, for example (not illustrated).

Each of the optional venue host devices 108(1)-108(n) of the network environment 100 in this example includes any type of computing device that can exchange network data, such as mobile, desktop, laptop, or tablet computing devices, virtual machines (including cloud-based computers), or the like. Each of the venue host devices 108(1)-108(n) in this example includes a processor, a memory, and a communication interface, which are coupled together by a bus or other communication link (not illustrated), although other numbers or types of components could also be used.

Each of the venue host devices 108(1)-108(n) may run interface applications, such as standard web browsers or standalone applications, which may provide an interface to communicate with the collaboration management device 102 via the communication network(s) 104(1). Each of the venue host devices 108(1)-108(n) may further include a display device, such as a display screen or touchscreen, or an input device, such as a keyboard or mouse, for example (not illustrated).

Each of the web servers 110(1)-110(n) in this example includes one or more processors, a memory, and a communication interface, which are coupled together by a bus or other communication link, although other numbers and types of network devices could be used. The web servers 110(1)-110(n) in this example process requests (e.g., API requests) received from the collaboration management device 102 related to hosted content or services via the communication network(s) 104(2) according to the HTTP-based application RFC protocol, for example. Various applications may be operating on the web servers 110(1)-110(n) and transmitting data (e.g., files or web pages) to the collaboration management device 102. The web servers 110(1)-110(n) may be hardware or software or may represent a system with multiple servers in a pool, which may include internal or external networks.

Although the web servers 110(1)-110(n) are illustrated as single devices, one or more actions of each of the web servers 110(1)-110(n) may be distributed across one or more distinct network computing devices that together comprise one or more of the web servers 110(1)-110(n). Moreover, the web servers 110(1)-110(n) are not limited to a particular configuration. Thus, the web servers 110(1)-110(n) may contain a plurality of network computing devices that operate using a master/slave approach, whereby one of the network computing devices of the web servers 110(1)-110(n) operate to manage and/or otherwise coordinate operations of the other network computing devices. The web servers 110(1)-110(n) may operate as a plurality of network computing devices within a cluster architecture, a peer-to peer architecture, virtual machines, or within a cloud architecture, for example.

Although the exemplary network environment 100 with the client devices 106(1)-106(n), venue host devices 108(1)-108(n), collaboration management device 102, web servers 110(1)-110(n), and communication network(s) 104(1) and 104(2) are described and illustrated herein, other types or numbers of systems, devices, components, or elements in other topologies can be used. It is to be understood that the systems of the examples described herein are for exemplary purposes, as many variations of the specific hardware and software used to implement the examples are possible, as will be appreciated by those skilled in the relevant art(s).

One or more of the components depicted in the network environment 100, such as the client devices 106(1)-106(n), collaboration management device 102, venue host devices 108(1)-108(n), or web servers 110(1)-110(n), for example, may be configured to operate as virtual instances on the same physical machine. In other words, one or more of the client devices 106(1)-106(n), venue host devices 108(1)-108(n), collaboration management device 102, or web servers 110(1)-110(n) may operate on the same physical device rather than as separate devices communicating through communication network(s) 104(1) or 104(2). Additionally, there may be more or fewer client devices, venue host devices, collaboration management devices, or web servers than illustrated in FIG. 1.

The examples of this technology may also be embodied as one or more non-transitory computer readable media having instructions stored thereon, such as in the memory 202, for one or more aspects of the present technology, as described and illustrated by way of the examples herein. The instructions in some examples include executable code that, when executed by one or more processors, such as the processor(s) 200, cause the processors to carry out steps necessary to implement the methods of the examples of this technology that are described and illustrated herein.

Referring to FIG. 3, a flowchart of an exemplary method for location mapping to facilitate collaboration for users sharing common attributes is illustrated. In step 300 in this example, the collaboration management device 102 determines whether a request to onboard a new venue has been received from one of the venue host devices 108(1)-108(n). The request can be received via a mobile application executing on the venue host devices 108(1)-108(n) or an interface (e.g., web page) provided by the collaboration management device 102, for example. If the collaboration management device 102 determines that a request to onboard a new venue has been received, then the Yes branch is taken to step 302.

In step 302, the collaboration management device 102 obtains and stores venue data including a geolocation (e.g., latitude/longitude coordinates or a street address) for the venue. The venue data can be stored in the venue database 210 optionally in association with a generated unique identifier for the venue. The venue data can include information regarding the venue, such as amenities, size, handicap accessibility, hours of operation, and/or type (e.g., coffee shop, bar, or library). In this example, the venues are open to the public, although private venues can also be onboarded in other examples.

While new venues are explicitly onboarded in this example, in other examples the collaboration management device 102 can link or interface directly with a third party database hosted by one or more of the web servers 110(1)-11(n) (e.g., a database hosted by the Google Maps Platform™ available from Alphabet Inc. of Mountain View, CA) for one or more portions of the venue data. In these examples, the venue database 210 may not be used and, instead, third party databases at the web servers 110(1)-110(n) can be queried as described and illustrated in more detail below. Subsequent to obtaining and storing the venue data, or if the collaboration management device 102 determines a request to onboard a new venue has not been received and the No branch is taken from step 300, then the collaboration management device 102 proceeds to step 304.

In step 304, the collaboration management device 102 determines whether a request to onboard a new user has been received from one of the client devices 106(1)-106(n). In one example, a user of one of the client devices 106(1)-106(n) can download the collaboration application 112(1)-112(n) and submit a request for login credentials via the downloaded collaboration application 112(1)-112(n). In other examples, the request to onboard a new user can be generated by a separate enterprise device (e.g., an access management device) during onboarding for all new employees. Other methods of generating the request to onboard a new user can also be used in other examples. If the collaboration management device 102 determines that a request to onboard a new user has been received, then the Yes branch is taken to step 306.

In step 306, the collaboration management device 102 obtains and stores user data including identification data in the user database 208. The identification data can include an employee ID, name, or any other unique identifier for the user. The user data can also include an indication of an associated organization, a role, department, or business unit of the user in the organization, for example, and/or any other attributes for user. Subsequent to obtaining and storing the user data, or if the collaboration management device 102 determines a request to onboard a new user has not been received and the No branch is taken from step 304, then the collaboration management device 102 proceeds to step 308.

In step 308, the collaboration management device 102 determines whether a login request has been received from a user of one of the client devices 106(1)-106(n), which can be the newly-added user in step 306 or another previously-registered user. Accordingly, the login request can be received via one of the collaboration applications 112(1)-112(n) in some examples. If the collaboration management device 102 determines that a login request has not been received then the No branch is taken back to step 300. Accordingly, the collaboration management device 102 effectively waits for a request to onboard a new venue or a new user, or for a login request. If the collaboration management device 102 determines that a login request has been received in step 308, then the Yes branch is taken to step 310.

In step 310, the collaboration management device 102 obtains venue parameter(s) after authenticating the user of the one of the client devices 106(1)-106(n) from which the login request was received. The user can be authenticated based on login credentials stored in the user database 208 in step 306, for example, although other authentication methods (e.g., single sign-in (SSO)) can also be used. Additionally, the venue parameter(s) can be obtained via a venue parameter interface 400 generated by the collaboration management device 102 and provided to the one of the client devices 106(1)-106(n) (e.g., via one of the collaboration applications 112(1)-112(n)).

The venue parameter(s) can be any characteristic of a physical space as established by the authenticated user. Exemplary venue parameter(s) can include a type, amenities (e.g., Wi-Fi service, free parking, projector, whiteboard, voice/video communications, etc.), accessibility requirements (e.g., handicap accessibility, ground floor access, etc.), and/or size (e.g., physical size, seating, etc.). Any other venue parameter(s) that can be compared and correlated with the venue data obtained and stored in step 302, and/or as explained below with reference to step 314, can also be used in other examples.

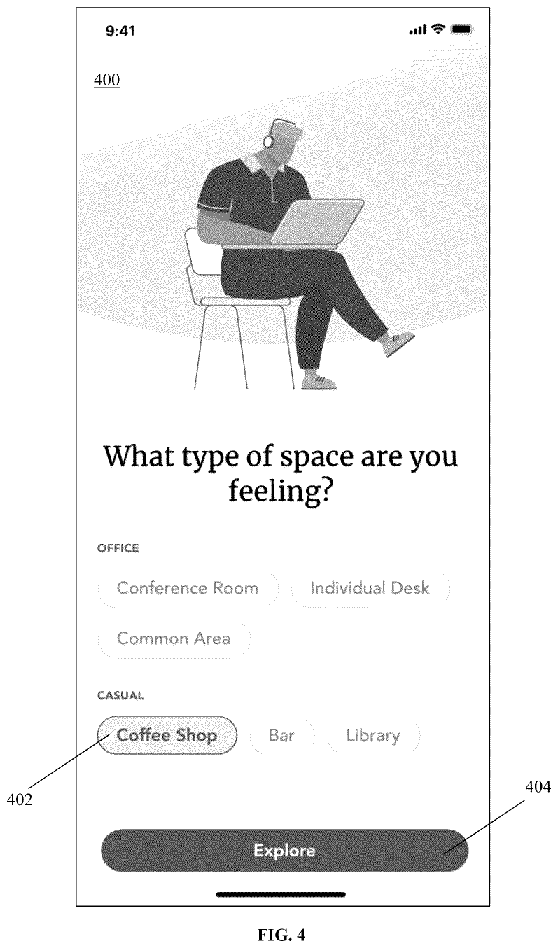

Referring to FIG. 4, an exemplary venue parameter interface 400 is illustrated. In this example, a user of the one of the client devices 106(1)-106(n) can input a venue type parameter (e.g., coffee shop) via a venue type button 402, but any other number or type of venue parameter(s) can be specified by the authenticated user of the one of the client devices 106(1)-106(n) via the venue parameter interface 400.

Referring back to FIG. 3, in step 312, the collaboration management device 102 identifies venues satisfying the venue parameter(s) and having a venue geolocation within a radius of a determined current geolocation of the authenticated user. The current geolocation of the authenticated user can be determined by pinging the one of the client devices 106(1)-106(n) executing one of the collaboration applications 112(1)-112(n) to obtain the geolocation via a global positioning system (GPS) service executing on the one of the client devices 106(1)-106(n). In another example, the current geolocation of the authenticated user can be explicitly provided by the authenticated user in the form of a street address or other geolocation, for example.

The radius used by the collaboration management device 102 to filter and identify the venues can be a default or predefined radius applied for all users or a radius set by the authenticated user. In other examples, the radius can be dynamic and based on a number of identified venues such that the radius is increased until a threshold number of venues are identified, for example. The radius can be established in other ways and/or other radii can be used in other examples.

The collaboration management device 102 can determine whether a venue satisfies the venue parameter(s) based on a comparison of the venue parameter(s) to the venue data for the venue. The venue data can be obtained in step 306 and/or stored in the venue database 210. Alternatively, the collaboration management device 102 can provide the current geolocation of the authenticated user to one or more third party application programming interfaces (APIs) or other endpoints hosted by one or more of the web servers 110(1)-110(n) to obtain an indication of the venues and/or venue data associated with each of the venues.

For example, the Google Maps Platform™ available from Alphabet Inc. of Mountain View, CA and the OpenTable™ platform available from Booking Holdings Inc. of San Francisco, CA each provide an API that can be used by the collaboration management device 102 to obtain venue data. In some examples, the venue data can include venue images, amenities, reviews, and/or any other information that can be compared to the venue parameter(s) obtained in step 310.

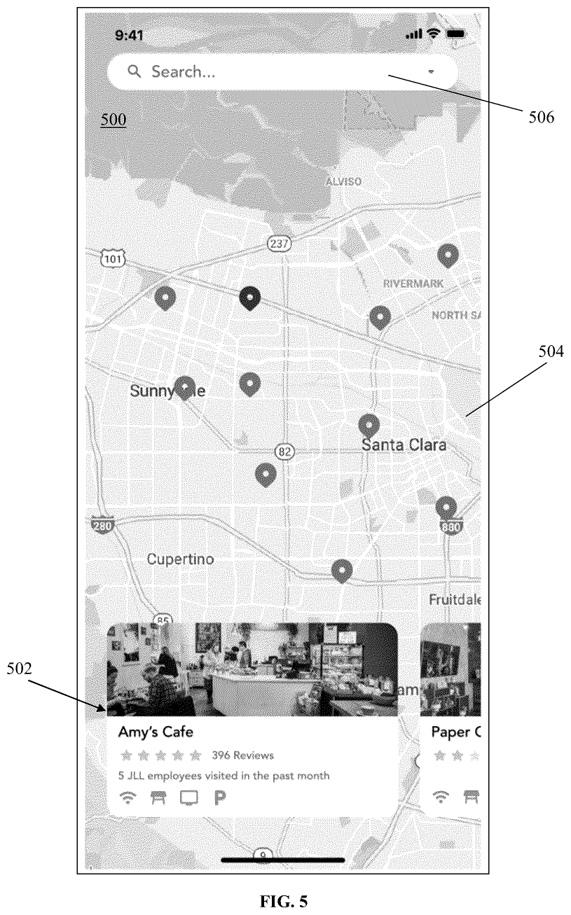

Referring to FIG. 5, an exemplary venue preview interface 500 is illustrated. In this example, the venue parameter interface 400 of FIG. 4 includes an explore button 404 that, when selected by the authenticated user of the one of the client devices 106(1)-106(n) causes the collaboration management device 102 to initiate queries to the venue database 210 or one or more of the web servers 110(1)-110(n) to perform step 312 of FIG. 3 and generate and provide the venue preview interface 500 of FIG. 5.

The venue preview interface 500 in this particular example includes a venue preview listing 502 overlaid on a map 504. The venue preview listing 502 includes selectable indications of the venues determined to be within the radius of the geolocation of the authenticated user. Optionally, the selectable indications can include a portion of the venue data (e.g., a venue rating) and/or visit data for the associated venue that is stored in and retrieved from the venue database 210. The visit data in this particular example includes a number of coworker users that have visited a venue in a historical time period. The coworker users are identified based on an association in the user database 208 with a same organization as the authenticated user. The visit data can be maintained and updated as described and illustrated in more detail later with reference to step 322 of FIG. 3. Other information can also be provided in the venue preview listing and/or selected indications in other examples.

The map of the venue preview interface 500 optionally includes selectable markers associate with the obtained geolocations for the venues. When one of the markers is selected, the venue preview listing can automatically scroll to present a selectable indication associated with one of the venues corresponding to the selected marker. The search field 506 of the venue preview interface 500 can be used to filter the venues included in the venue preview listing 502 based on a keyword search of venue data obtained for the venues, for example.

In step 314, the collaboration management device 102 identifies registered user(s) within another radius of a venue geolocation for a selected venue based on determined current geolocations for the registered user(s). The radius can be the same as, or overlap with, the radius used to identify the initial set of venues in step 312, although a smaller or larger static or dynamic radius can also be used. The venue can be selected based on a selection by the authenticated user of a corresponding one of the venue indications of the venue preview listing 502 of FIG. 5, for example.

Upon receiving the selection of the venue, the collaboration management device 102 can retrieve the venue geolocation for the venue from the venue database 210 or the venue data obtained in step 312, for example, which is used to identify the registered user(s) based on the radius. The current user geolocations of the registered user(s) can be determined by pinging those of the client device(s) 106(1)-106(n) that are associated with the registered user(s) and executing one of the collaboration applications 112(1)-112(n) to obtain the current user geolocations via a GPS service executing on the client devices 106(1)-106(n).

In step 316, the collaboration management device 102 generates and outputs (e.g., via a venue selection interface 600) social data for the venue that is generated from user data for the registered user(s). The user data used to generate the social data can be retrieved from the user database 208 using a unique identifier for the registered user(s) identified in step 314, for example. In one particular example, the social data can include a number of the registered user(s) having particular roles within an organization associated with the authenticated user as indicated in the user data. In other examples, the social data can include a number of the registered user(s) within particular teams, departments, and/or business units in the same organization as the authenticated user, and any other attributes in the stored user data that the registered user(s) may have in common with each other and/or with the authenticated user can also be used in other examples.

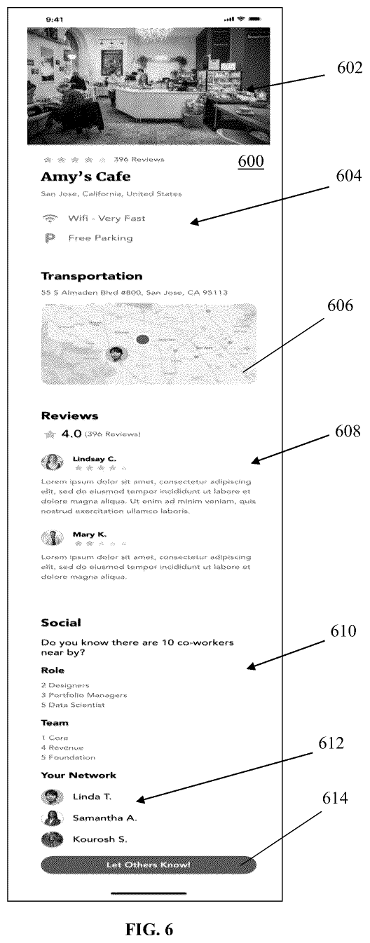

Referring to FIG. 6, an exemplary venue selection interface 600 is illustrated. The venue selection interface 600 can be generated and provided to the one of the client devices 106(1)-106(n) by the collaboration management device 102 after the collaboration management device 102 receives a selection of one of the venues. Accordingly, the venue selection interface 600 includes portions of the venue data obtained in step 312 and/or additional venue data for the selected venue obtained in the same manner as described above with reference to step 312.

In this particular example, the venue selection interface 600 includes an image 600 of the venue, an amenities description 604 for the venue, a map 606 showing a location of the venue, a set of reviews 608 for the venue, and the social data 610 generated in step 316, although other information can also be provided on the exemplary venue selection interface 600 in other examples. The social data 610 in this particular example indicates the number of registered users within a particular radius of the venue geolocation of the selected venue that have an associated designer, portfolio manager, and data scientist role, as well as the number of the registered user(s) in the core, revenue, and foundation teams, within a same organization as the authenticated user.

Optionally, the venue selection interface 600 can also include network data 612, which can include an indication of those of the identified registered user(s) that are within a same network as the authenticated user. The collaboration management device 102 can generate the network data 612 by leveraging APIs provided by a third party social media network and identifiers for the registered user(s) and the authenticated user to identify connection(s) between the authenticated user and the registered user(s). In other examples, the network can be an internal network of connection facilitated and maintained by the collaboration management device 102 in the user database 208, and other types of networks and network data can also be used in other examples. With the venue selection interface 600, the authenticated user can select a let other know button 614 to move forward or go back to the venue preview interface 500 to select another venue from the venue preview listing 512.

Referring back to FIG. 3, in step 318, the collaboration management device 102 receives a time window from the authenticated user of the one of the client devices 106(1)-106(n) in this example in which the authenticated user decided to move forward with the selected venue (e.g., via selection of the let others know button 614 of the venue selection interface 600). The collaboration management device 102 can generate and provide to the one of the client devices 106(1)-106(n) a scheduling interface (e.g., scheduling interface 700) to facilitate receipt of the time window. Optionally, the collaboration management device 102 can also receive from the authenticated user an indication of a subset of the registered user(s) identified in step 314.

In step 320, the collaboration management device 102 sends digital invitations to those of the client devices 106(1)-106(n) associated with the registered user(s) identified in step 314 (or a subset thereof). The collaboration management device 102 can automatically send digital calendar invitations (e.g., via a push notification and the corresponding collaboration applications 112(1)-112(n)) to those of the client devices 106(1)-106(n) associated with the identified registered user(s). An indication of the collaboration applications 112(1)-112(n) and/or the associated client devices 106(1)-106(n) can be maintained in the user database 208 to facilitate the push notifications as well as the identity of the registered user(s) for which the associated user geolocation was determined to be within the radius of the venue geolocation in step 314. In other examples, e-mails, short message service (SMS) messages, and/or any other type of communication can be initiated by the collaboration management device 102 based on stored contact information in the user data in order to facilitate the digital invitations.

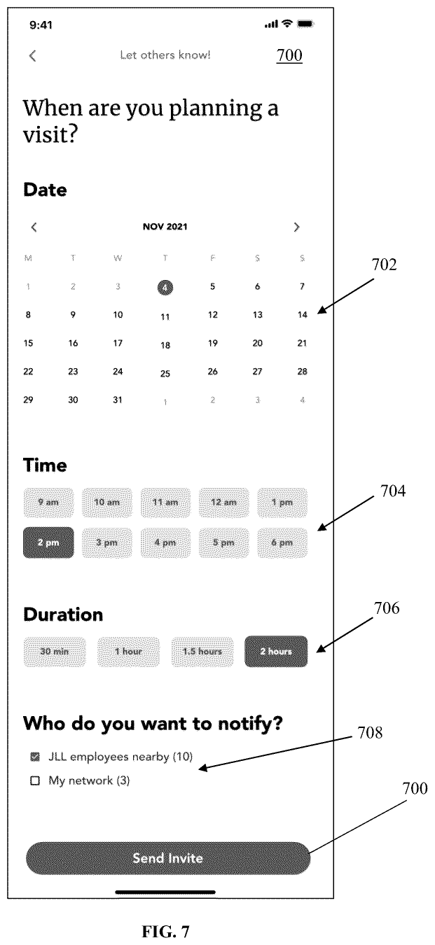

Referring to FIG. 7, an exemplary scheduling interface 700 is illustrated. In this example, the scheduling interface 700 is generated to include selectable time windows corresponding to a date 702, time 704, and duration 706. Additionally, the scheduling interface 700 includes registered user selection fields 708 that in this particular example allow a user to select a subset of the registered use(s) associated with a same organization as the authenticated user or a same network as the authenticated user. Other types of selections (e.g., based on role, team, department, business unit, or other user attribute) can be facilitated in the user selection fields 708 in other examples. Upon inputting the various time window and registered user selections, and selecting with the send invite button 710, the collaboration management device 102 automatically sends the digital invitations to the subset of the registered user(s) based on the time window in this example.

Additionally, the collaboration management device 102 optionally receives a request to calendar the visit to the venue from the authenticated user of the one of the client devices 106(1)-106(n), which in some examples causes the collaboration management device 102 to generate a digital calendar invitation for the authenticated user or automatically update a stored calendar in examples in which the collaboration management device 102 is authorized by the authenticated user to do so. Other methods for processing requests to calendar the meeting can also be used in other examples.

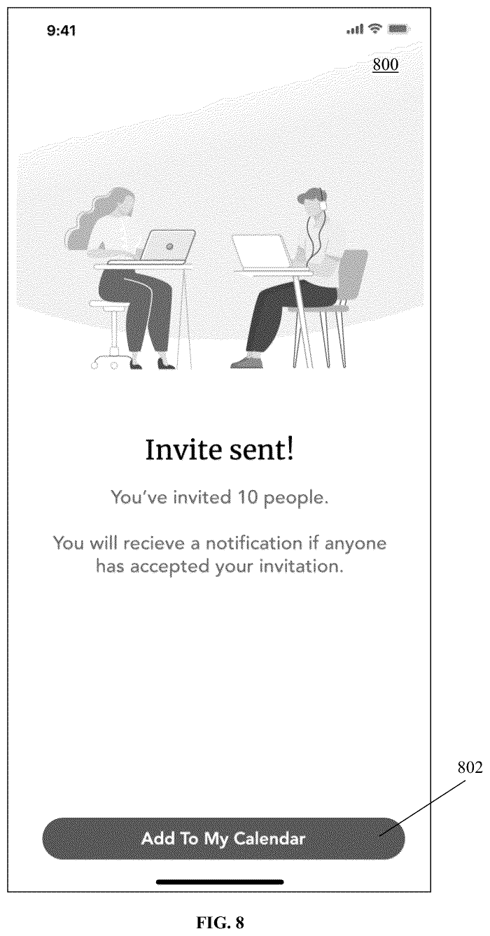

Referring to FIG. 8, an exemplary calendaring interface 800 is illustrated. In this example, the collaboration management device 102 generates and provides the calendaring interface 800 to the one of the client devices 106(1)-106(n) to allow the authenticated user to add the visit to the venue to the user's calendar via interaction with an add to my calendar button 1002. Other information and/or functionality can also be provided via the calendaring interface 800 in other examples.

Referring back to FIG. 3, in step 322, the collaboration management device 102 receives response(s) to the digital invitations, outputs a notification to the one of the client devices 106(1)-106(n) (e.g., via one of the collaboration applications 112(1)_112(n)), and updates stored visit data for the venue (e.g., as stored in the venue database 210). The responses can be initiated based on interaction with acceptance functionality provided with the digital invitations that allows those of the client devices 106(1)-106(n) associated with the invited registered user(s) to initiate a message indicating an acceptance to the collaboration management device 102, for example.

Optionally, the collaboration management device 102 can batch the responses and delay sending the notification for a predefined time period, although multiple notifications can also be sent and other methods for notifying the authenticated user can also be used. Accordingly, the notification can include at least a portion of the stored user data (e.g., a user identity) for at least a subset of the invited registered user(s) associated with one or more of the client devices 106(1)-106(n) from which a positive response to the digital invitations was received.

The visit data for the selected venue can then be updated to reflect a visit by the authenticated user and those of the registered user(s) from which an acceptance of one of the digital invitations was received. Accordingly, the collaboration management device 102 can store an indication (e.g., unique identifier) for the authenticated user and each of the accepted registered user(s) and/or any portion of the stored user data associated with those users. The updated visit data facilitates subsequent generation of the social data for the venue in another iteration of step 316. In some examples, the collaboration management device 102 can assume that each of the accepted registered user(s) visited the venue and, in other examples, information such as a geolocation during the time window correlated with the venue geolocation and/or a social media check-in, for example, can be used as confirmation of the visit for one or more of the accepted registered user(s).

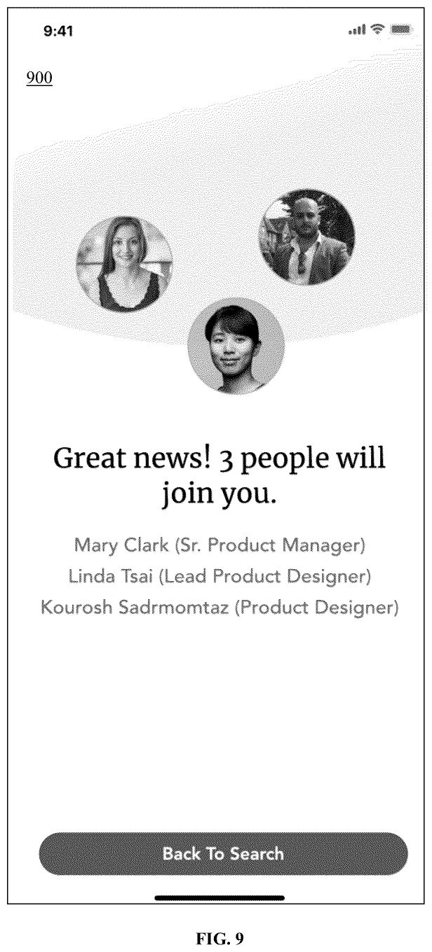

Referring to FIG. 9, an exemplary response interface 900 is illustrated. In this example, the response interface 900 is provided to the one of the client devices 106(1)-106(n) and includes the notification to the authenticated user. The notification includes the identity and role of each of the subset of the invited registered user(s) that accepted one of the digital invitations in this example, although the notification and/or response interface 900 can include other information in other examples. Referring back to FIG. 3, subsequent to updating the stored visit data in step 322, the collaboration management device 102 proceeds back to step 300 in this example. In other examples, one or more of steps 300-322 can be performed in parallel and/or in a different order than illustrated in FIG. 3.

As described and illustrated by way of the examples herein, this technology provides an improved collaboration management device that more effectively facilitates meetings and/or social interactions at venues for users that share common attributes, such as remote workers associated with a same organization. This technology obtains and correlates venue and user geolocations to generate a set of venues available for a user to visit. This technology then generates and provides to the user social data regarding users within a proximity of the venues, facilitates input of a time window for the visit, and automatically initiates digital invitations to, and manages response from, selected other users. Accordingly, this technology advantageously facilitates increased interactions among users sharing common attributes and can increase and improve the connections made within an associated organization.

Having thus described the basic concept of the invention, it will be rather apparent to those skilled in the art that the foregoing detailed disclosure is intended to be presented by way of example only, and is not limiting. Various alterations, improvements, and modifications will occur and are intended to those skilled in the art, though not expressly stated herein. These alterations, improvements, and modifications are intended to be suggested hereby, and are within the spirit and scope of the invention. Additionally, the recited order of processing elements or sequences, or the use of numbers, letters, or other designations therefore, is not intended to limit the claimed processes to any order except as may be specified in the claims. Accordingly, the invention is limited only by the following claims and equivalents thereto.

What is claimed is:

1. A method for location mapping to facilitate collaboration for users sharing common attributes, the method implemented by one or more collaboration management devices and comprising:
identifying a venue and one or more registered users within a first radius of a venue geolocation of the venue, wherein the venue satisfies one or more venue parameters received from a client device and the venue geolocation is within a second radius of a user geolocation of an authenticated user of the client device;
outputting to the client device social data for the venue generated from stored user data for the registered users;
sending one or more digital invitations to one or more client devices associated with one or more of the registered users;
outputting to the client device a notification including at least a portion of the stored user data for at least a subset of the one or more of the registered users associated with one or more of the client devices from which a positive response to the digital invitations was received; and
updating stored visit data for the venue to reflect a visit to the venue by the authenticated user and the subset of the one or more of the registered users.

2. The method of claim 1, further comprising:
pinging the client devices to determine user geolocations for the registered users via a collaboration application executing on the client devices and a global positioning system (GPS) service provided by the client devices; and
comparing the user geolocations to the venue geolocation to determine that the registered users are within the first radius.

3. The method of claim 1, further comprising determining from the stored user data one or more roles for the registered users within an organization associated with the authenticated user, wherein the social data comprises a number of the registered users having each of the roles and the portion of the stored user data comprises an identity of the subset of the one or more of the registered users.

4. The method of claim 1, further comprising:
determining a number of coworker users that have visited the venue in a historical time period based on the stored visit data for the venue, wherein the coworker users are associated in a stored user database with a same organization as the authenticated user; and
generating and providing to the client device a venue preview interface comprising selectable indications of a plurality of venues determined to be within the second radius, wherein one of the selectable indications for the venue comprises the number of coworker users.

5. The method of claim 4, wherein the digital invitations are sent after receipt of a first selection of the venue from the authenticated user and the method further comprises:
providing the user geolocation to a third party application programming interface (API) to obtain an indication of the venue and venue data associated with the venue, wherein the venue data comprises one or more images of the venue, one or more amenities of the venue, or one or more reviews of the venue; and
generating and providing to the client device a venue selection interface after receipt of a second selection of the one of the selectable indications, wherein the venue selection interface comprises at least a portion of the venue data.

6. The method of claim 1, further comprising:
generating and providing to the client device a scheduling interface to facilitate submission by the authenticated user of a time window and an indication of the one or more of the registered users; and
generating the digital invitations based on the time window.

7. A collaboration management device, comprising memory comprising programmed instructions stored thereon and one or more processors configured to execute the stored programmed instructions to:
identify a venue and one or more registered users within a first radius of a venue geolocation of the venue, wherein the venue satisfies one or more venue parameters received from a client device and the venue geolocation is within a second radius of a user geolocation of an authenticated user of the client device;
output to the client device social data for the venue generated from stored user data for the registered users;
send one or more digital invitations to one or more client devices associated with one or more of the registered users;
output to the client device a notification including at least a portion of the stored user data for at least a subset of the one or more of the registered users associated with one or more of the client devices from which a positive response to the digital invitations was received; and
update stored visit data for the venue to reflect a visit to the venue by the authenticated user and the subset of the one or more of the registered users.

8. The collaboration management device of claim 7, wherein the processors are further configured to execute the stored programmed instructions to:
ping the client devices to determine user geolocations for the registered users via a collaboration application executing on the client devices and a global positioning system (GPS) service provided by the client devices; and
compare the user geolocations to the venue geolocation to determine that the registered users are within the first radius.

9. The collaboration management device of claim 7, wherein the processors are further configured to execute the stored programmed instructions to determine from the stored user data one or more roles for the registered users within an organization associated with the authenticated user, wherein the social data comprises a number of the registered users having each of the roles and the portion of the stored user data comprises an identity of the subset of the one or more of the registered users.

10. The collaboration management device of claim 7, wherein the processors are further configured to execute the stored programmed instructions to:
determine a number of coworker users that have visited the venue in a historical time period based on the stored visit data for the venue, wherein the coworker users are associated in a stored user database with a same organization as the authenticated user; and
generate and provide to the client device a venue preview interface comprising selectable indications of a plurality of venues determined to be within the second radius, wherein one of the selectable indications for the venue comprises the number of coworker users.

11. The collaboration management device of claim 10, wherein the digital invitations are sent after receipt of a first selection of the venue from the authenticated user and the processors are further configured to execute the stored programmed instructions to:
provide the user geolocation to a third party application programming interface (API) to obtain an indication of the venue and venue data associated with the venue, wherein the venue data comprises one or more images of the venue, one or more amenities of the venue, or one or more reviews of the venue; and
generate and provide to the client device a venue selection interface after receipt of a second selection of the one of the selectable indications, wherein the venue selection interface comprises at least a portion of the venue data.

12. The collaboration management device of claim 7, wherein the processors are further configured to execute the stored programmed instructions to:
generate and provide to the client device a scheduling interface to facilitate submission by the authenticated user of a time window and an indication of the one or more of the registered users; and
generate the digital invitations based on the time window.

13. A non-transitory computer readable medium having stored thereon instructions for location mapping to facilitate collaboration for users sharing common attributes comprising executable code which when executed by one or more processors, causes the processors to:
identify a venue and one or more registered users within a first radius of a venue geolocation of the venue, wherein the venue satisfies one or more venue parameters received from a client device and the venue geolocation is within a second radius of a user geolocation of an authenticated user of the client device;
output to the client device social data for the venue generated from stored user data for the registered users;
send one or more digital invitations to one or more client devices associated with one or more of the registered users;
output to the client device a notification including at least a portion of the stored user data for at least a subset of the one or more of the registered users associated with one or more of the client devices from which a positive response to the digital invitations was received; and
update stored visit data for the venue to reflect a visit to the venue by the authenticated user and the subset of the one or more of the registered users.

14. The non-transitory computer readable medium of claim 13,
wherein the executable code when executed by the processors further causes the processors to:
ping the client devices to determine user geolocations for the registered users via a collaboration application executing on the client devices and a global positioning system (GPS) service provided by the client devices; and
compare the user geolocations to the venue geolocation to determine that the registered users are within the first radius.

15. The non-transitory computer readable medium of claim 13, wherein the executable code when executed by the processors further causes the processors to determine from the stored user data one or more roles for the registered users within an organization associated with the authenticated user, wherein the social data comprises a number of the registered users having each of the roles and the portion of the stored user data comprises an identity of the subset of the one or more of the registered users.

16. The non-transitory computer readable medium of claim 13, wherein the executable code when executed by the processors further causes the processors to:
determine a number of coworker users that have visited the venue in a historical time period based on the stored visit data for the venue, wherein the coworker users are associated in a stored user database with a same organization as the authenticated user; and
generate and provide to the client device a venue preview interface comprising selectable indications of a plurality of venues determined to be within the second radius, wherein one of the selectable indications for the venue comprises the number of coworker users.

17. The non-transitory computer readable medium of claim 16, wherein the digital invitations are sent after receipt of a first selection of the venue from the authenticated user and the executable code when executed by the processors further causes the processors to:
provide the user geolocation to a third party application programming interface (API) to obtain an indication of the venue and venue data associated with the venue, wherein the venue data comprises one or more images of the venue, one or more amenities of the venue, or one or more reviews of the venue; and
generate and provide to the client device a venue selection interface after receipt of a second selection of the one of the selectable indications, wherein the venue selection interface comprises at least a portion of the venue data.

18. The non-transitory computer readable medium of claim 13, wherein the executable code when executed by the processors further causes the processors to:
generate and provide to the client device a scheduling interface to facilitate submission by the authenticated user of a time window and an indication of the one or more of the registered users; and
generate the digital invitations based on the time window.
